(19) United States
(12) Patent Application Publication
(10) Pub. No.: US 2019/0026293 A1
(43) Pub. Date: Jan. 24, 2019

(54) Location- and Interest-Based Social Media Platform

(71) Applicants: Sharvil Shah, Lake Forest, CA (US); Richard Ruiz, Long Beach, CA (US)

(72) Inventors: Sharvil Shah, Lake Forest, CA (US); Richard Ruiz, Long Beach, CA (US)

(21) Appl. No.: 16/041,839

(22) Filed: Jul. 23, 2018

Related U.S. Application Data
(60) Provisional application No. 62/535,800, filed on Jul. 21, 2017.

(51) Int. Cl. G06F 17/30; G10L 13/08; G06Q 30/02; G06Q 50/00

(52) U.S. Cl. CPC G06F 17/3087; G06F 17/30041; G06Q 50/01; G10L 13/08; G06Q 30/0251; G06F 17/30867

(57) ABSTRACT

A social media platform is provided having location-based or interest-based or interest location-based searching or viewing capabilities, wherein the user may select a specific location or specific interest or both to view or post. The user of provided social media platform has option of privacy settings, tailored or customized feeds based upon selected location, interest or both for viewing or posting. The user may also access the posted content from social media platform in a video or audio format. The user further has an option to conduct wild card searches for any terms within real-time feeds or content generated according to a selected location or selected interest or both.

### BACKGROUND OF THE INVENTION

### Field of the Invention

The present invention relates to communication and more specifically to online social media networking through a location-based and interest-based system. More particularly, the invention relates to a method of searching or viewing contents, posts and feeds on online social media platform with an option of generating content according to a specific location or a specific interest or both to its users.

### Description of the Related Art

Most social media platforms offer to users the ability to post content viewable only to themselves, viewable to friends, or viewable to the public, but may not offer specific location- or interest-based options or feeds to the users. Some users may wish to publish content viewable or related to a specific geographical location, but do not have the option to do so. Some users may also wish to use a social media platform integrated with text-to-speech features. For example, users with visual impairment, may wish to use a social media platform with integrated text-to-speech features rather than having to use an additional third-party application for text-to-speech features or services. Some users may also wish to utilize text-to-speech features to have social media feed content and comments be read to them, for multi-tasking purposes. Users may also wish to use the location features of a location-based social media platform that appear to not be currently available, such as, for example, performing a wildcard search in a particular area, limiting feed views to certain desired geographical locations, or posting content onto specific forums with geographical restrictions. Therefore, there is a need for a solution to these problems.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### SUMMARY OF THE INVENTION

This Summary is provided to introduce a selection of concepts in a simplified form that are further described below in the Detailed Description of the invention. This Summary is not intended to identify key aspects or essential aspects of the claimed subject matter. Moreover, this Summary is not intended for use as an aid in determining the scope of the claimed subject matter.

It is an object of the present invention to provide a social media platform having location-based or interest-based searching or viewing capabilities, wherein the user may select a geographical region or a specific interest to view or post content. Thus, an advantage is that a user may have options or privacy settings for their content, and may select tailored or customized feeds for viewing or posting content.

It is an additional object of this invention to provide a social media platform having location-based or interest-based searching or viewing capabilities, wherein the user may select a geographical region or a specific interest to view or post content, wherein the social media platform is integrated with text-to-speech features. Thus, an advantage is that a user may have options or privacy settings for their content, may select tailored or customized feeds for viewing or posting content, and may access the content from the social media platform in a video or audio format. Another advantage may be that visually impaired users may be able to hear the content originally posted in a text format.

It is a further object of this invention to provide a social media platform having location-based or interest-based searching or viewing capabilities, wherein the user is provided with advertisements related to the relevant content customized as per the selected location or selected interest or both.

It is another object of this invention to provide a social media platform having location-based or interest-based searching or viewing capabilities, wherein the user has an option to conduct wild card searches for any terms within real-time feeds or content customized as per the selected location or selected interest or both. There is also an option to hold peer-to-peer interaction within groups or forums, wherein the users of said social media platform can directly interact and discuss any topic of interest.

It is a yet another object of this invention to provide a social media platform having location-based searching or viewing capabilities, wherein the user may select and lock a geographical region he plans to travel to display specific and relevant content or select customized feed for the locked geographical region.

In a first embodiment, a method for searching or viewing on a social media platform having location-based capabilities in a general user interface comprising selecting a geographical region from a menu with various locations provided to a user; displaying relevant content as feeds in a personalized view panel generated based upon selection of a specific location from said menu for said user to view or post; searching for any desired content within real-time feeds displayed in said personalized view panel; integrating with text-to-speech features thereby accessing said displayed content in a video or audio format in said personalized view panel; providing single or plurality of advertisements to said user in an advertisement panel generated based upon location selected by said user.

In a second embodiment, a method for searching or viewing on a social media platform having interest-based capabilities in a general user interface comprising: selecting a specific interest from a menu with various interests provided to a user; displaying relevant content as feeds in a personalized view panel generated based upon selection of a specific interest from said menu to view or post; searching for any desired content within real time feeds displayed on said personalized view; integrating with text-to-speech features thereby accessing said displayed content in a video or audio format in said personalized view; providing single or plurality of advertisements to each user in an advertisement panel generated based upon the selection of said interest by said user.

In a third embodiment, a method for searching or viewing on a social media platform in specific interest at specific location in a general user interface comprising: selecting a specific interest from a menu with various interests provided to a user; selecting a geographical region from a menu with various locations provided to said user; displaying relevant content as feeds in a personalized view panel generated based upon the selection of a specific interest at a specific location from said menu to view or post; searching for any desired content within real time feeds displayed on said personalized view; integrating with text-to-speech features thereby accessing said displayed relevant content in a video or audio format in said personalized view; providing single or plurality of advertisements to each user in an advertisement panel generated based upon the selection of said interest at a specific location by said user.

In a fourth embodiment, a method for searching or viewing on sports location-based social media platform in a general user interface comprising: selecting sports of interest from a menu provided to a user; selecting favorite teams from said menu provided to a user; selecting a geographical region from a menu with various locations provided to said user; selecting sources related to said sports of interest and said favorite teams from selected location to generate relevant content; displaying relevant content as feeds in a personalized view panel customized based upon selection of said sports of interest and said favorite teams for selected location; searching for any desired content within real time feeds displayed on said personalized view; integrating with text-to-speech features thereby accessing said displayed relevant content in a video or audio format in said personalized view; providing single or plurality of advertisements to each user in an advertisement panel generated based upon selection of said sports of interest, said favorite teams and said selected geographic region.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates an example of a general user interface that may be accessed by a user to use a location- or interest-based social media platform, according to an aspect.

FIG. 2 illustrates an example of a user interface showing a city view, according to an aspect.

FIG. 3 illustrates another example of a user interface showing a user-selected city view, according to an aspect.

FIG. 4 illustrates another example of a user interface showing a state or region view, according to an aspect.

FIG. 5 illustrates an example of a user interface showing a country view, according to an aspect.

FIG. 6 illustrates an example of a user interface showing a world view, according to an aspect.

FIG. 7A illustrates an example of a user interface showing a view specific to a user's selected interest or topic, such as sports as shown by, according to an aspect.

FIGS. 7B-7H illustrate additional examples of a user interface which can be applied to industries such as sports, showing a personalized sports feed, according to an aspect.

FIG. 8 illustrates another example of a user interface showing a view specific to a user's selected interest or topic, according to an aspect.

FIG. 9 illustrates another example of a user interface showing a news feed, specific to a user's selected interest or topic, according to an aspect.

FIGS. 10A-10B show examples of general user interfaces that may be accessed by a user to use a location- or interest-based social media platform through a computer, and through a mobile device, respectively, according to an aspect.

FIGS. 11A-11G show specific examples of a user interface of sports-location-based social media platform that may be accessed by a user through a desktop computer or laptop showing a personalized sports feed relevant to user selected locations, according to an aspect.

FIG. 12 illustrates an example of a user interface accessed on a mobile device showing a view of news feed and other relevant content specific to sports, according to an aspect.

### DETAILED DESCRIPTION OF THE INVENTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

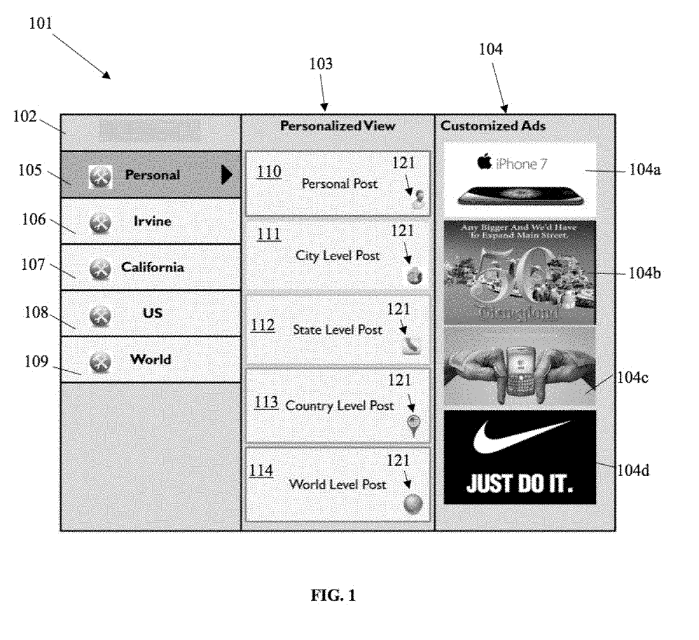

FIG. 1 illustrates an example of a general user interface 101 that may be accessed by a user to use a location- or interest-based social media platform (“location-based social media platform,” “location-based social media,” “interest-based social media platform,” “interest-based social media,” or “social media platform”), according to an aspect. As an example, a general user interface 101 may provide the user with various menus, such as a selection menu 102, a detailed personalized view 103 (“personalized view,” “view menu” or “view panel”) for viewing the selection from the selection menu 102, and a panel for customized ads 104 (“customized ads,” “ad panel,” or “ad menu”).

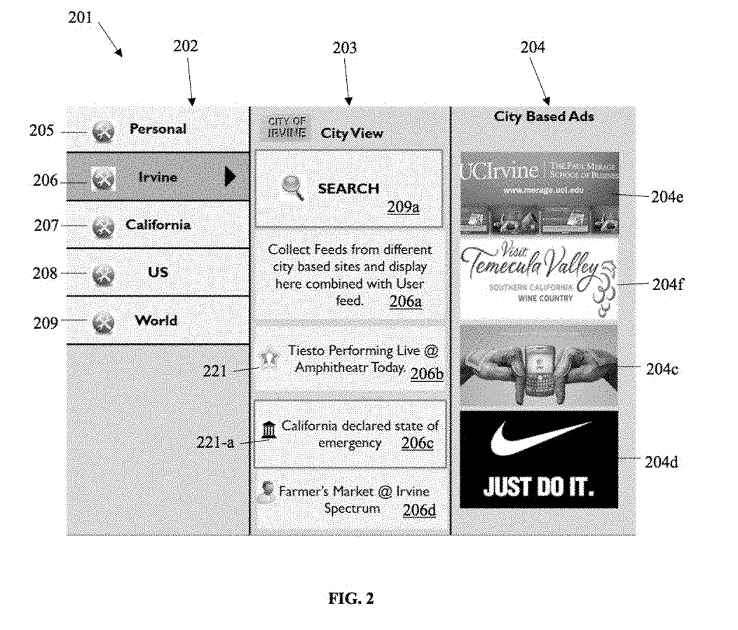

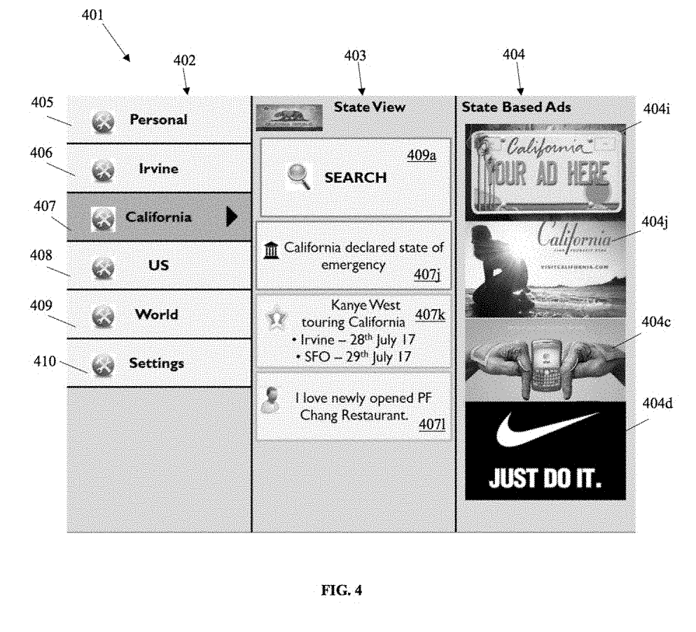

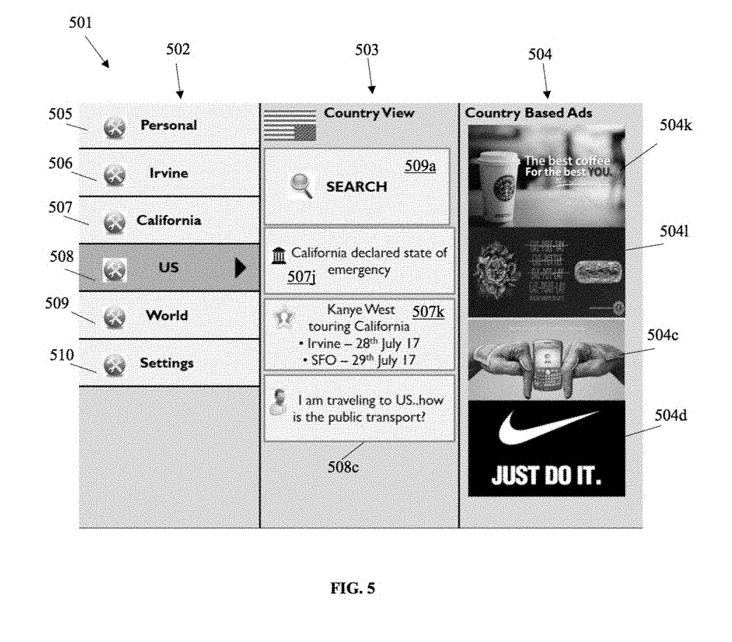

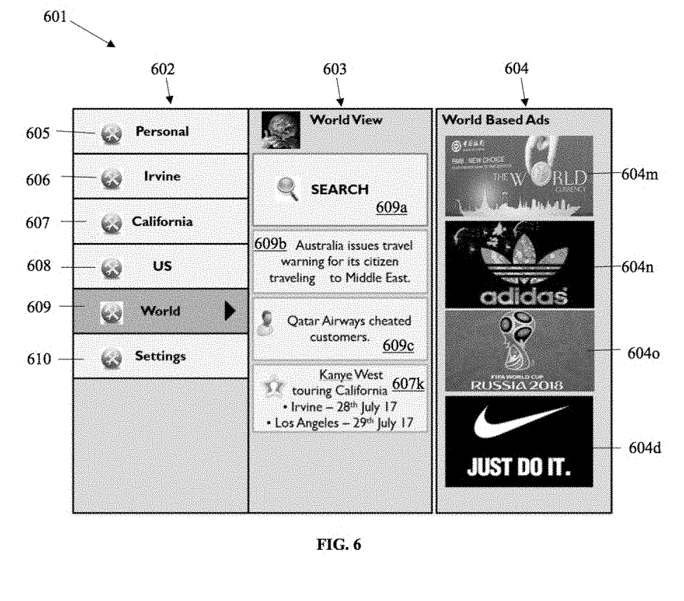

The user interface 101 may allow the user to select a region or type of post from a selection menu 102, for example. The selection menu may include choices such as a personal view 105, a city view 106, a state view 107, a country view 108, or a world view 109. As shown as examples, various locations may be provided to the user, or may be selected by the user to be displayed in the selection menu 102. As shown as examples, the city view 106 may be displayed as a specific city, such as Irvine, and the state view 107 may show California, and the country view 108 may show U.S. Upon selection of a particular menu item 105-109 from the selection menu 102, the user may be shown a personalized view based on the selection in a view panel 103. As an example, selection of a personal feed 105 may display a personalized feed or view 103, which may be all posts personalized to the user. These personalized posts may be at various regional levels; for example, personalized posts may be city level, state level, country level, and may be independent of other tabs 106, 107, 108, and 109. These personalized views may display only the posts from the user, or the user's selected friends. Selection of a city, such as Irvine 106, may display a city level post or feed (as shown by 203 in FIG. 2). Selection of a state or province, such as California 107, may display a state or province level feed (as shown by 403 in FIG. 4). Selection of a country, such as U.S. 108, may display a country level post or feed (as shown by 503 in FIG. 5) Selection of world view 109 may display a world level post or feed (as shown by 603 in FIG. 6). Users may make the feed level selections in order to determine the feed to which they wish to post a message, photo, or any other type of content. The user may, for example, post content and set the publication settings to “self” such that it is viewable only by the user, or set to “friends” such that specified other users of the social media platform may view the content, or post to a specific city, state or province, country, or world. The user may choose to post anonymously, for example, and may also choose to post privately or publicly, or only to certain regions. An advantage may be that the user may have a large degree of control over the visibility of their posted content, and may also have many options for searching for content.

The personalized view 103 may display individual posts with color-coding, for example, or may include visual representations or icons 121 to signify the type of post, such as, for example, whether the post was created by the user or by a friend. The visual representation 121 may also indicate to the user the location or region that the post originated from. The user may also be provided with the ability to search the personalized view 103 (as shown by 609a in FIG. 6, not shown in FIG. 1 for visual clarity).

The social media platform may, for example, also be integrated with text-to-speech capabilities, features, or services. The text-to-speech features may provide the user with options to play content as video or audio on external devices, such as televisions, computers, or other similar devices. The user may play their content in video or audio format, and may then be able to seamlessly play content from their feed from the location- or interest-based social media platform regardless of whether the content is originally in text, audio, or video form. An advantage may be that users with visual impairment may be able to listen to the content originally posted in a text format. The software of the social media platform may be configured such that when playing feed content as audio or video, the play may be continuous and play each item in the feed until stopped by the user. The user may also enable or disable playing of comments on individual posts. An advantage may be that ease of access to the content may be increased for the user.

The user may also be provided with an option to perform wildcard searches for any desired topic within real time conversation feeds within the location- or interest-based social media platform. The user may have the option to search for specific terms within content posted to a selected city, or state, or country, or at the world level, for example, and the search parameters may be customized to search at any regional level desired. Thus, the searched conversations may be specific to a particular region, such that the user may easily find specialized information such as ratings for various content, recommendations, trends, and so on for that particular region. The user may also be provided with options to hold peer-to-peer interactions on specific forums. An advantage may be that the user may be able to find and directly interact with other users of the social media platform in a particular city or region. As an example, a user interested in seeing a specific play at a theater in a particular city, such as Paris, may search for reviews and discussions about the production, venue, actors, special events, and ticket exchange related to the play, regardless of the user's current geographical location. The user may also have the option to directly interact with other Paris users about the play by posting and reading within the Paris city page.

The searched forums may be personal and include selected friends and family members, or may be interest-based, or may be region- or location-based. As an example, a user with a rare type of cancer or disease may post about their experiences or questions on a restricted forum dedicated to that disease. The user may also choose to post anonymously to any level of access. For example, the user may post anonymously to a particular city, a particular state, or at the world level, and so on.

The customized ad panel 104 may include advertisements tailored or customized to each user. The ad panel 104 may contain a single ad, for example, or may contain a plurality such as the examples shown as 104a-104d. The social media platform may, for example, be agnostic to individual users' data sources, operating systems, or hardware.

FIG. 2 illustrates an example of a user interface 201 showing a city view, according to an aspect. Again, the user may have the option of selecting a personal view 205, a city view 206, a state or region view 207, a country view 208, or world view 209. When selecting a city view 206, the panel for the personalized view 203 may show a feed custom for a selected city. The city feed or view 203 may display content from the city that the user is located in, and may change automatically as the user changes locations, such as, for example, by the mobile device running the software of the social media platform detecting the user's location. The city feed or view 203 may display content specific or relevant to that city. As an example, city-related content may be collected from different city-based websites and aggregated (as shown by 206a). As additional examples, announcements for events such as concerts for particular artists may be shown (as shown by 206b), news related to the city or overall region the city is located in (as shown by 206c) and other informational announcements for activities such as a city farmer's market (as shown by 206d). Additional examples of announcement content that may be shown in the feeds of various cities are: Ties to performing live at the Universal Amphitheatre in Los Angeles, a wine festival in Temecula Valley, shopping at the Irvine Spectrum, a Lion King performance at the Pantages Theater in Hollywood, a volleyball tournament in Manhattan Beach, skiing conditions in Big Bear, or spring break in Palm Springs. Other examples of content that may be viewable from the city-based feed may include information specific to that city such as restaurant happy hours or other special deals, sports updates, job listings, personal posts from other users of the location-based social media platform, options or resources for buying and selling event tickets, options to join various leagues, and groups that can be joined by the user. The user may have the option of customizing their personalized panel 203. As an example, the user may choose to have news plus event announcements for a particular city shown on their personalized feed 203, for example. Additionally, city feeds may also include posts from other users updating their status. A status may include text posts, photos, images, audio, video, or any other suitable content.

The user may also be provided with the ability to search for any content within the city feed by selecting a search option 209a. The posts of the city feed 203 or posts found within a search of the city feed 203 may be marked with visual indicators, representations, or icons 221 to signify the type of post, or the origin of the post. As an example, branches of government such as city councils may be certified or verified with the provider of the location-based social media platform, and may then have the ability to show a particular icon 221-a on their posts. Other such icons shown with posts may be celebrity icons, or general user icons.

When a city is selected for viewing under the personalized panel, the ad panel 204 may show tailored or customized advertisements for that city such as the examples shown as 204e and 204f, and the ad panel 204 may also display general advertisements such as the examples shown as 204c and 204d.

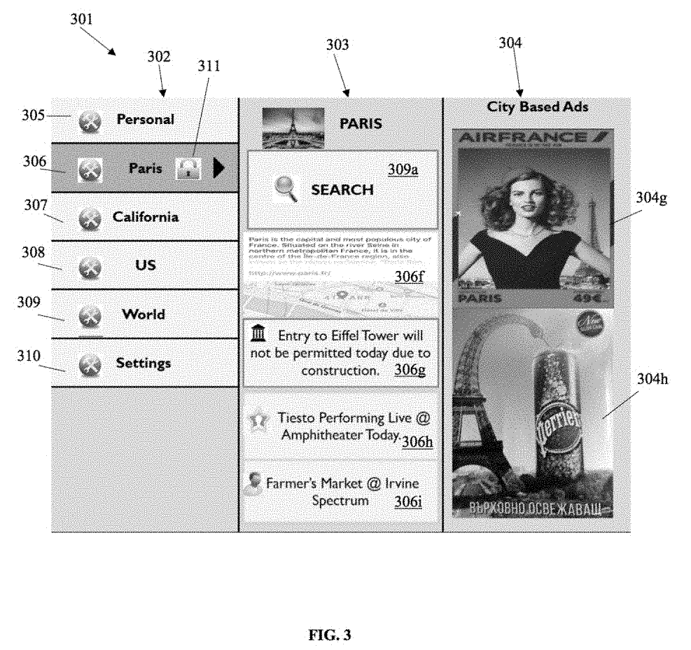

FIG. 3 illustrates another example of a user interface 301 showing a user-selected city view, according to an aspect. Again, the user may have the option to select a personal view 305, a city view 306, a state or region view 307, a country view 308, or world view 309, and the user may also have the option to select settings 310 to customize their experience using the social media platform. When selecting a city view 306, the user may be provided with the option to lock any particular city to their city view or feed 303, such that traveling or changing locations does not change the city shown in the personalized city view 303. As an example, a user residing in or located in a city may select a different city's feed to be shown in the city view 303. An advantage may be that a user traveling to another city may view information about the city prior to arriving. For example, a user living in California may set or lock their city view 303 to show the feed from Paris, France. A visual representation or icon 311 may be provided to the user to signify that a particular location has been locked for viewing. The locked city feed 303 may display content specific or relevant to that city, such as the examples shown as 306f, 306g, 306h, and 306i. The user may also be provided with the ability to search 309a the locked city. The user's locked city view 303 may also show an ad panel 304 that contains ads tailored or customized to the locked city, such as the examples shown as 304g and 304h.

FIG. 4 illustrates another example of a user interface 401 showing a U.S. state view, according to an aspect. As an example, provinces or other regions may be shown in place of a U.S. state. Again, the user may have the option to select a personal view 405, a city view 406, a state or region view 407, a country view 408, or world view 409, and the user may also have the option to select settings 410 to customize their experience using the social media platform. Selection of the state view 408 may show a custom state or region feed in the personal panel 403. The state, province, or region feed 403 may display content specific or relevant to that area, such as the examples shown such as news headlines 407j, event information or announcements 407k, and personal posts from other users 4071. Again, similar to the discussion when referring to FIG. 3, the user may choose to lock the feeds of a specific state or region. As an example, a user located in California may lock the state of Florida to thus receive feed content from Florida. Additionally, when a user is physically in a specific state or region, the user may receive posts users have posted in different cities of that locked state. A user viewing the posts of California may receive posts from all cities within California, such as Irvine, Los Angeles, San Francisco, and so on. An advantage may be that a user visiting the region and interested in attending celebration or holiday events may search cultural events taking place within the state.

Again, the user may also search 409a within the state or region posts. The social media platform may be configured such that content posted specifically to a particular city is not shown in the state or region view 403, but content posted to a state or region may be shown in the feed for all cities within the state or region. The social media platform may also be configured such that the user may choose to disable or enable showing state content within city views, for example.

Again, additional examples of content that may be viewable from the state- or region-based feed may include information specific to that state or region, such as restaurant happy hours or other special deals, sports updates, job listings, personal posts from other users of the location-based social media platform, options or resources for buying and selling event tickets, options to join various leagues, and groups that can be joined by the user. When a state, province, or region is selected for viewing under the personalized panel, the ad panel 404 may show tailored or customized advertisements for that area such as the examples shown as 404i and 404j, and the ad panel 404 may also display general advertisements such as the examples shown as 404c and 404d.

FIG. 5 illustrates an example of a user interface 501 showing a country view, according to an aspect. Again, the user may have the option to select a personal view 505, a city view 506, a state or region view 507, a country view 508, or world view 509, and the user may also have the option to select settings 510 to customize their experience using the social media platform. Selection of the country view 508 may show a country feed 503 in the personalized panel. The country feed 503 may display content specific or relevant to a particular country, such as the examples shown such as news 507j and personal posts from other users within the country 508c. The user may also search 509a the country feed. As an example, some content may be relevant at the city, state, and country level, and may be displayed under both a city view and a country view. As an example, certain news headlines 507j and event information 507k may be seen in the country view as well as the state view (as shown by 407j and 407k in FIG. 4). Again, additional examples of content that may be viewable from the state- or region-based feed may include information specific to that state or region, such as restaurant happy hours or other special deals, sports updates, job listings, personal posts from other users of the location-based social media platform, options or resources for buying and selling event tickets, options to join various leagues, and groups that can be joined by the user. When a country is selected for viewing under the personalized panel, the ad panel 504 may show tailored or customized advertisements for that country such as the examples shown as 504k and 5041, and the ad panel 504 may also display general advertisements such as the examples shown as 504c and 504d. Again, similar to the discussion when referring to FIG. 5, the user may be able to lock a country view. For example, the user visiting the U.S. may lock the U.S. as their country and search cultural events such as fairs concerts, and fireworks displays occurring throughout the country by state. Additionally, if a user's country views and search are refined by the user's settings, the user may be able to more specifically search for events such as environmentally friendly light displays instead of fireworks shows within a certain region or area, such as the Pacific Northwest. As another example, a user interested in attending a fair with German influence may be interested in visiting states in the Midwest, and may search within those regions by performing a country search, and further refining their search results.

FIG. 6 illustrates an example of a user interface 601 showing a world view, according to an aspect. Again, the user may have the option to select a personal view 605, a city view 606, a state or region view 607, a country view 608, or world view 609, and the user may also have the option to select settings 610 to customize their experience using the social media platform. The user may be provided with a search function 609a, such that feeds from a particular level of feed may be searched for desired content. As an example, the user may search in the world view 603 such that all posts may be searched, or all posts designated to the world level may be searched. The world view feed 603 may display content relevant at the worldwide level, such as the examples shown as 609b and 609c. Content at the world level may include news topics that affect worldwide users, such as news about wars, pandemics, geo-politics, and so on. Again, some content may be relevant at various regional levels. For example, certain news headlines or event announcements may be visible in a city view and also a state view, and also the world view. As examples, the content shown as an example as 607k in the world view may also be seen in a country view (as shown by 507k in FIG. 5). In the worldwide view, the ad panel 604 may display advertisements such as the examples shown as 604m, 604n, 604o, and 604d, which may include general advertisements relevant to any user, or may include advertisements tailored to individual users.

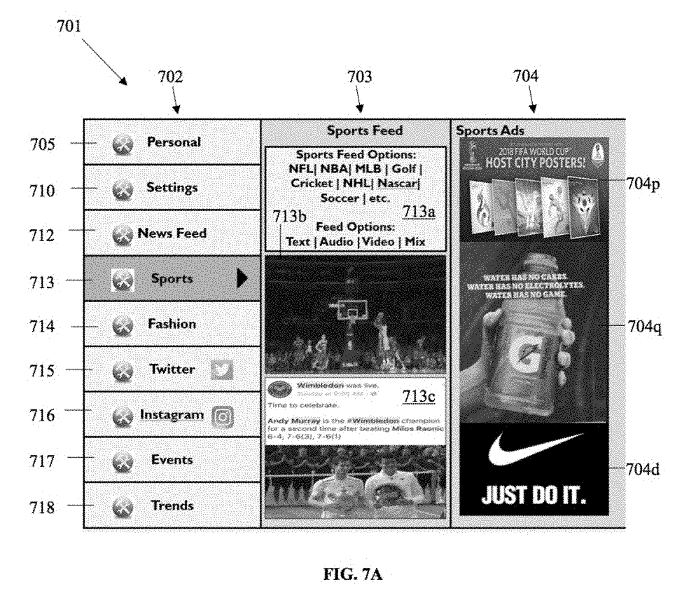

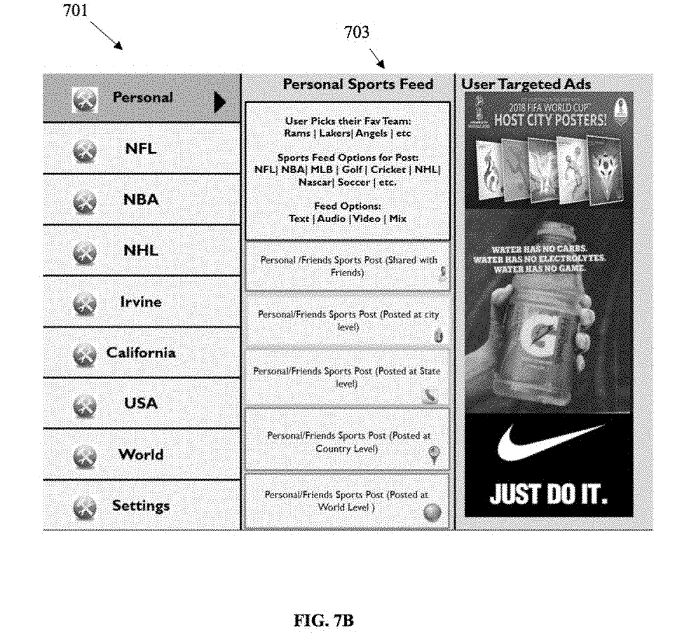

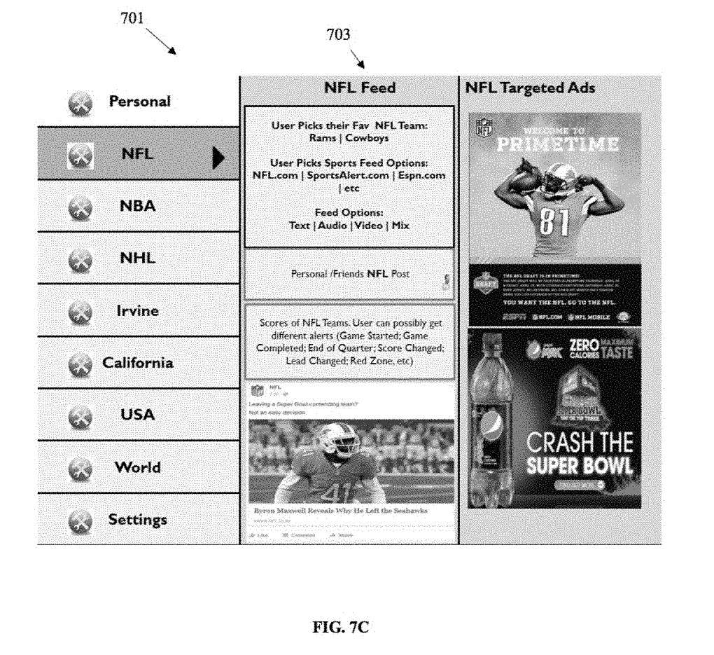

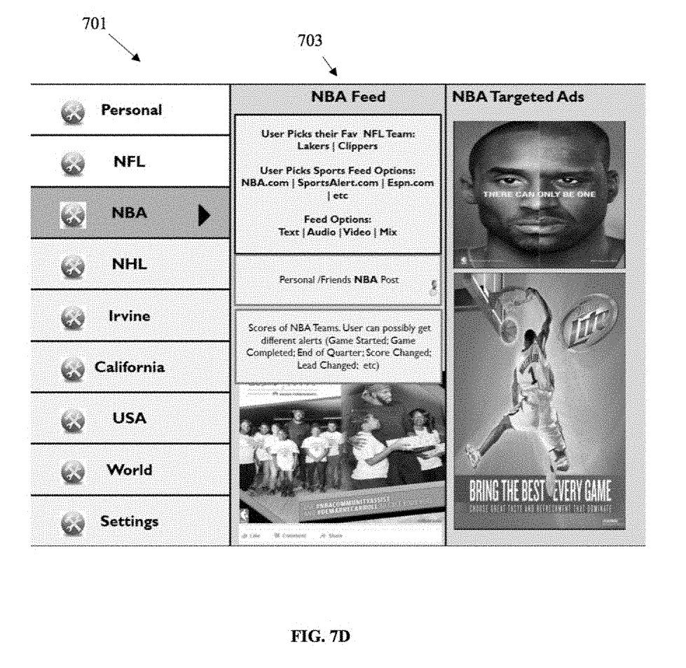

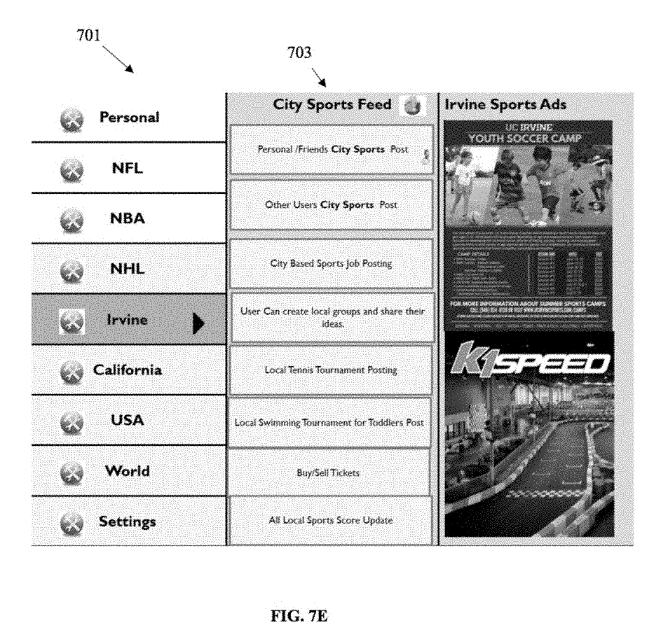

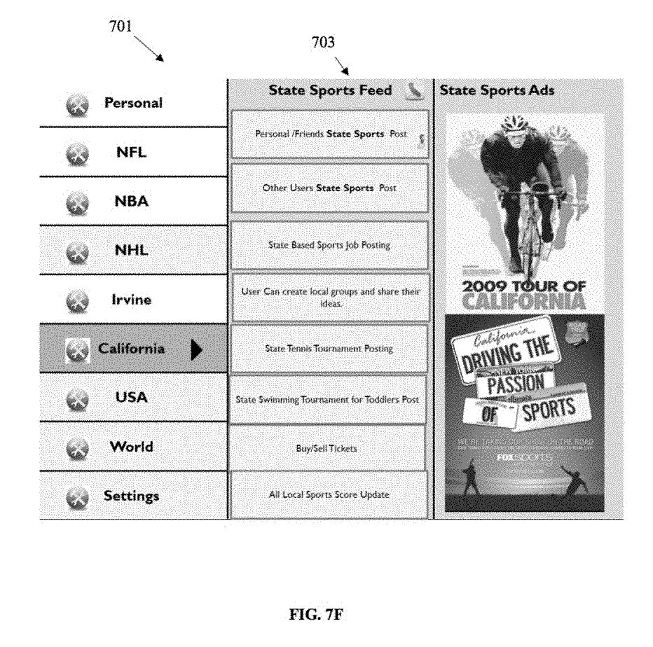

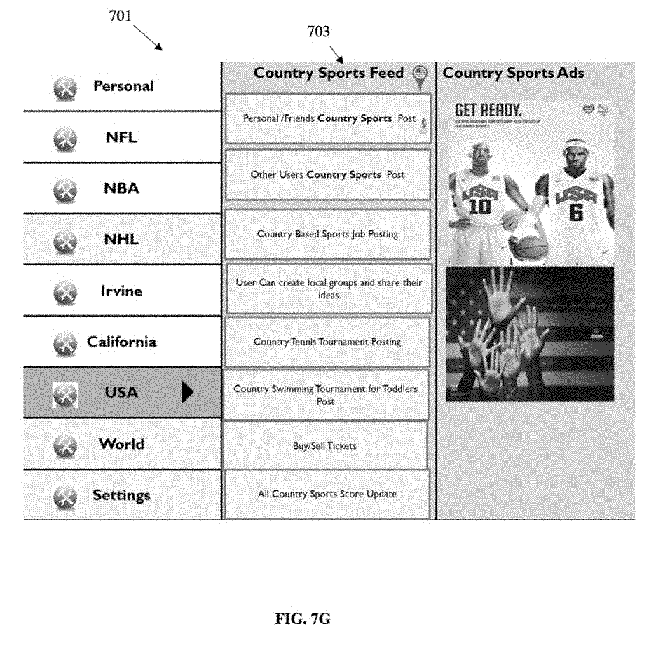

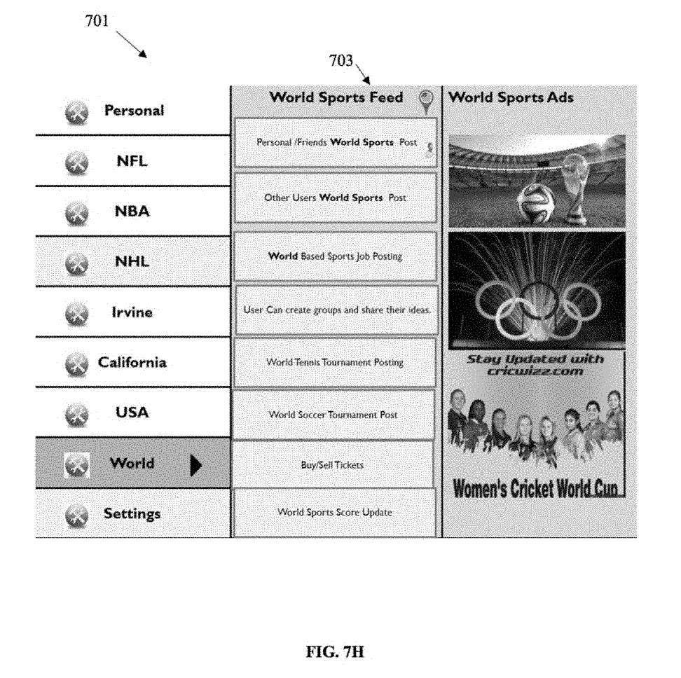

FIG. 7A illustrates an example of a user interface 701 showing a view specific to a user's selected interest or topic (“interest feed,” “interest view,” “topic view,” “topic feed,” or “personalized interest feed”), such as sports as shown by 701, according to an aspect. Again, the user may select any interest, topic, or industry to be shown in the personalized feed. The interest-based social media platform may provide the user with a selection menu 702 having selections for sports 713, fashion 714, feeds showing integration or cross-posting or cross-reading with other social media platforms 715 and 716, events 717, and trends 718, for example. As an example, the personalized view 703 may show a sports feed when sports 713 is selected from the selection menu 702, and the user may have the ability to post content specifically to a sports feed. The user may also be provided with options for configuring the interest feed. As examples, the user may be able to choose a sport, choose websites from which news reports and other posts are aggregated, and choose favorite teams to view feeds about. The user may also be provided with the option to view their feed as audio, video, text, or a combination. As an example, the user may be provided with a settings menu to toggle or select various options. The sports feed 703 may also display content relevant or related to the user's sports interests, such as the examples shown as 713a, 713b, and 713c. Additional examples of content that may be viewable from the interest feed 703 may include sports job listings, expert reports, articles, blogs, fan posts, options to buy or sell tickets to sporting events, integration with fantasy sports platforms, live score updates, and so on. The interest-based social media platform may be integrated with or may have access to external websites or platforms for sports-related services. An ad panel 704 may be displayed when the user has selected an interest feed 703, and the ads may be custom or tailored to the selected interest. For example, selection of sports feed 703 may display advertisements that are relevant or related to sports, such as, for example, sports related merchandise or items for sale 704p, sports drinks 704q, athletic gear or clothing 704d, and sports betting websites (not shown).

FIG. 7B illustrates another example of a user interface 701 which can be applied to industries such as sports, showing a personalized sports feed, according to an aspect. As an example, the user may be provided with the ability to select a favorite team or teams for which news may be shown on the feed 703. The feed 703 may also display all content, such as pictures, videos, comments, related to the team or teams posted to various regional levels by the user.

FIG. 7C illustrates another example of a user interface 701 showing a personalized sports feed, according to an aspect. As an example, the user may be provided with the ability to select a favorite team or teams, such as an NFL team as shown as an example, for which news may be shown on the feed 703. The user may first choose a favorite team. Next, the user may choose a source where content will be pulled from. As an example, the social media platform may provide the user with a variety of sports websites from which news may be pulled. Next, the user may choose the type of posts to be shown, such as text, audio, video, or a mixture. The feed 703 may also display all content, such as pictures, videos, comments, related to the team or teams posted to various regional levels by the user. The user may choose to have their sports feed 703 show all content posted by themselves and by their friends, for example.

FIG. 7D illustrates another example of a user interface 701 which can be applied to industries such as sports, showing a personalized sports feed, according to an aspect. As an example, the user may be provided with the ability to select a favorite team or teams, such as an NBA team, for which news may be shown on the feed 703. The user may first choose a favorite team. Next, the user may choose a source where content will be pulled from. As an example, the social media platform may provide the user with a variety of sports websites from which news may be pulled. Next, the user may choose the type of posts to be shown, such as text, audio, video, or a mixture. The feed 703 may also display all content, such as pictures, videos, comments, related to the team or teams posted to various regional levels by the user. The user may choose to have their sports feed 703 show all content posted by themselves and by their friends, for example.

FIG. 7E illustrates another example of a user interface 701 which can be applied to industries such as sports, showing a personalized sports feed 703 at a city level, according to an aspect. As an example, the user may be provided with an option to customize a feed 703 to show all relevant sports-related news for a particular city. Examples of content that may be shown in the customized city sports feed 703 may be city-based sports job postings, posts from other users of the social media platform, information about events or sports games in the city, local tournament information, means for buying and selling tickets, and local sports scores. The user may also have the ability to create local groups to share ideas.

FIG. 7F illustrates another example of a user interface 701 which can be applied to industries such as sports, showing a personalized sports feed 703 at a state level, according to an aspect. Similar to the sports feed at a city level, the sports feed 703 at a state or region level may provide the user with options for posting about sports related to a specific state, province or region. Content posted within the state level sports feed 703 may include personal posts, posts by friends of the user, state-based sports job postings, local groups relating to sports at the state level, tournament or other event information, features for buying and selling tickets, and state sports score updates.

FIG. 7G illustrates another example of a user interface 701 which can be applied to industries such as sports, showing a personalized sports feed at a country level, according to an aspect. Again, similar to the sports feed at a city level, the sports feed 703 at a state or region level may provide the user with options for posting about sports related to a specific country. Again, content posted within the country level sports feed 703 may include personal posts, posts by friends of the user, country-based sports job postings, local groups relating to sports at the country level, tournament or other event information, features for buying and selling tickets, and country sports score updates.

FIG. 7H illustrates another example of a user interface 701 showing a personalized sports feed 703 at the world level, according to an aspect. Again, content posted within the world level sports feed 703 may include personal posts, posts by friends of the user, worldwide sports job postings, groups relating to sports, tournament or other event information, features for buying and selling tickets, and worldwide sports score updates.

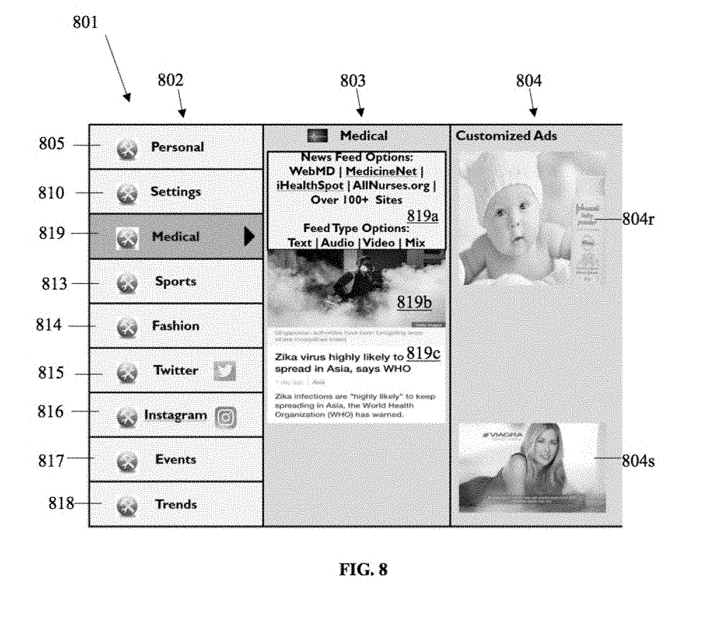

FIG. 8 illustrates another example of a user interface 801 showing a view specific to a user's selected interest or topic, according to an aspect. Again, the user may select any interest, topic, or industry to be shown in the personalized feed. The user may be provided with several options in the selection menu 802 for an interest-based feed such as medical 819, sports 813, fashion 814, cross-posting or cross-reading with other social media platforms (such as the examples shown in 815 and 816), events 817, or trends 818. As an example, the personalized view 803 may show a medical feed 803. The medical feed 803 may be related to certain topics within the medical field, such as, for example, a rare type of cancer, or contraction of the Zika virus or other types of viruses. Within those specialized interest feeds, users may exchange information regarding symptoms, recent developments or advancements related to diseases, medical facilities, and physicians who are highly regarded in the treatment of certain conditions. The interest-based social media platform may also be integrated with or may have access to external websites or platforms for services related to the interest selected by the user, such as, for example, services in the medical industry. Again, an ad panel 804 may be displayed when the user has selected an interest feed 803, and the ads may be custom or tailored to the selected interest. For example, selection of a medical industry feed 803 may display advertisements that are relevant or related to the medical industry, such as the examples shown as 804r and 804s.

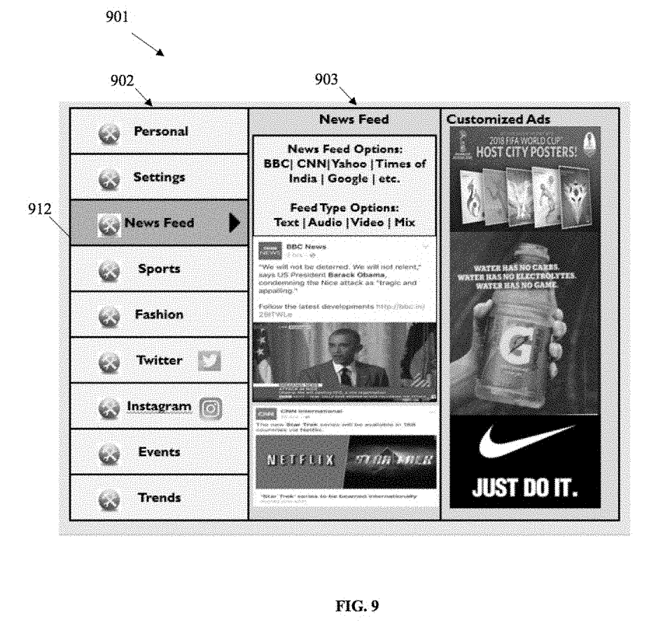

FIG. 9 illustrates another example of a user interface 901 showing a news feed 903, specific to a user's selected interest or topic, according to an aspect. Again, the user may select a particular topic such as news to be shown in the personalized feed 903. The user may be provided with options for interests in the selection menu 902, and the user may select a news feed 912. Selection of the news feed 912 may show a customized news feed panel 903. The user may select the news channels they wish to be shown in their feed, or types of topics to be shown, and may thus be shown headlines pertaining to their interests such as the examples shown. The software for the social media platform may also be provided with the ability to work with plugins or other downloadable content such that the user's news feed may be played through an external device, for example. As an example, the news feed of the social media platform may be played to the user through external speakers or television, with an established wireless connection between an electronic device running the social media platform software and the speakers. As another example, the user may select to have various interests or topics combined into a single feed.

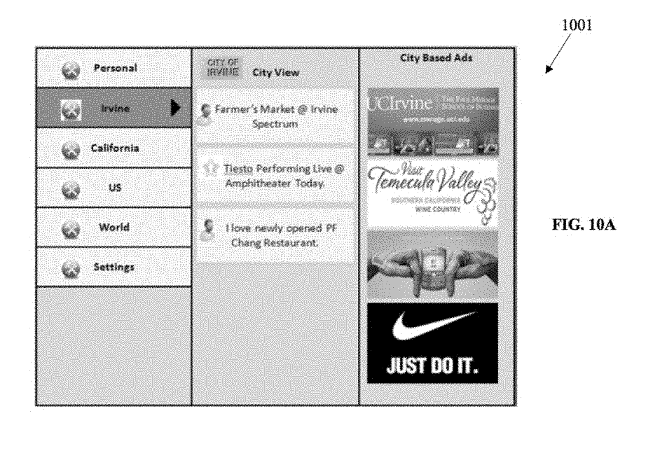

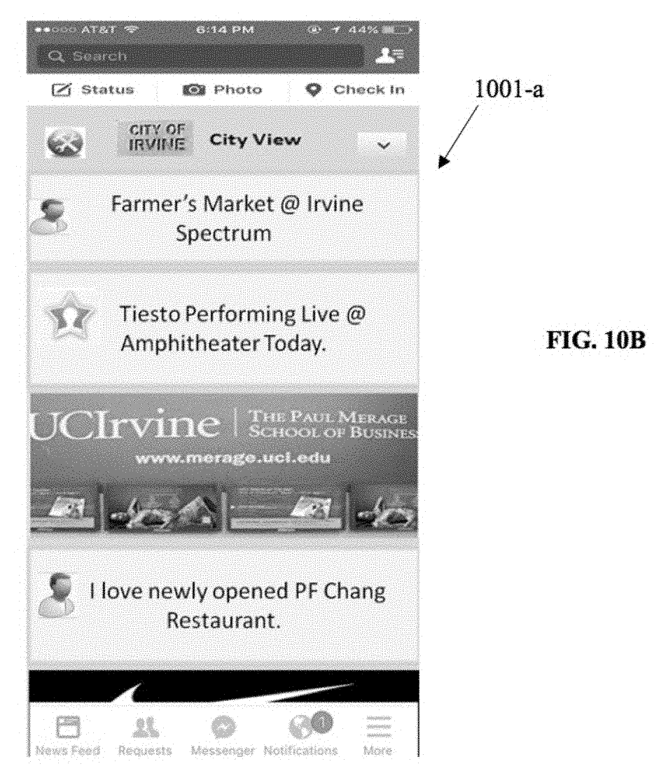

FIGS. 10A-10B show examples of general user interfaces 1001 and 1001-a that may be accessed by a user to use a location- or interest-based social media platform through a computer, and through a mobile device, respectively, according to an aspect. As an example, the social media platform may be access through any suitable device that may be capable of connection to the internet. The user interface presented to the user may have different views according to the device used to access the social media platform. For example, the user may view a large general interface 901 when accessing the social media platform through a desktop or laptop computer, or may view a compact mobile version of the general user interface 1001-a when accessing the social media platform through any mobile device. The social media platform software may be configured such that the mobile interface 1001-a randomly generates a view of posts and ads. For example, a view may be generated having four posts and one ad, as shown as an example in 1001-a, or may include a different number of posts and ads. The social media platform may, for example, be accessed through any suitable mobile device such as a tablet, smartphone, or any other portable internet-connected device.

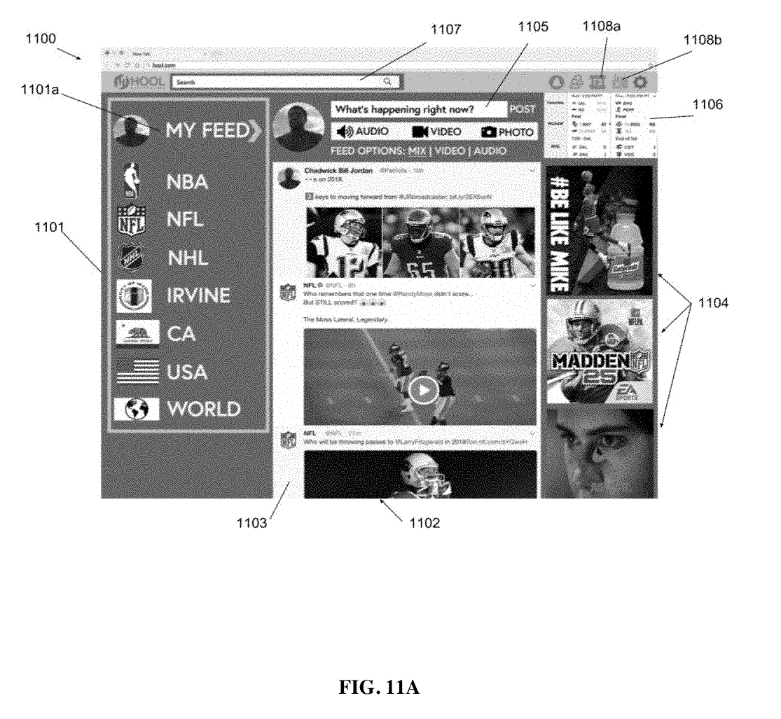

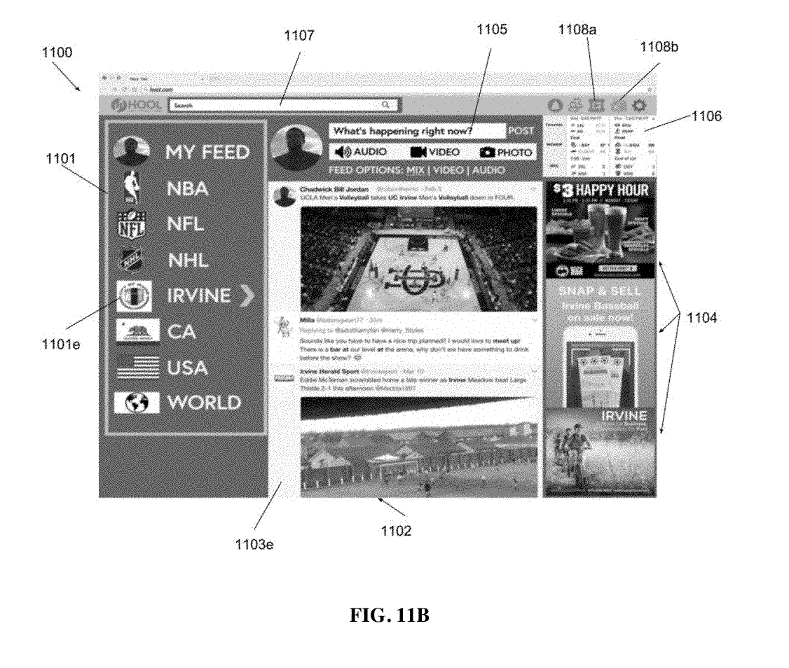

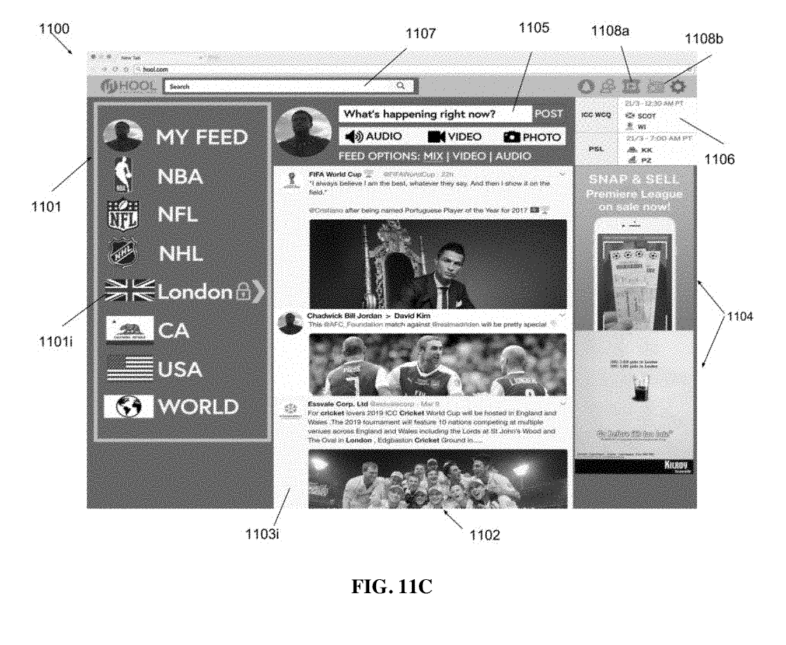

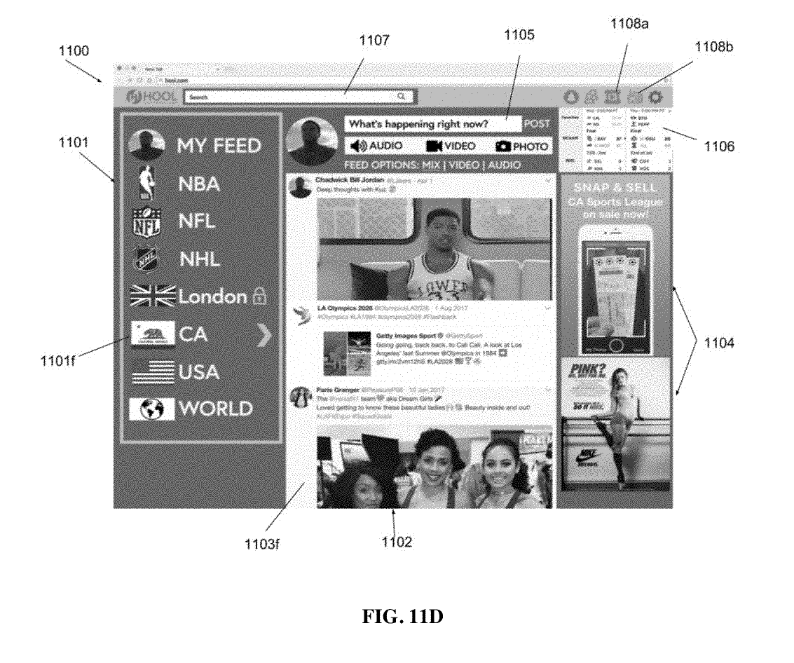

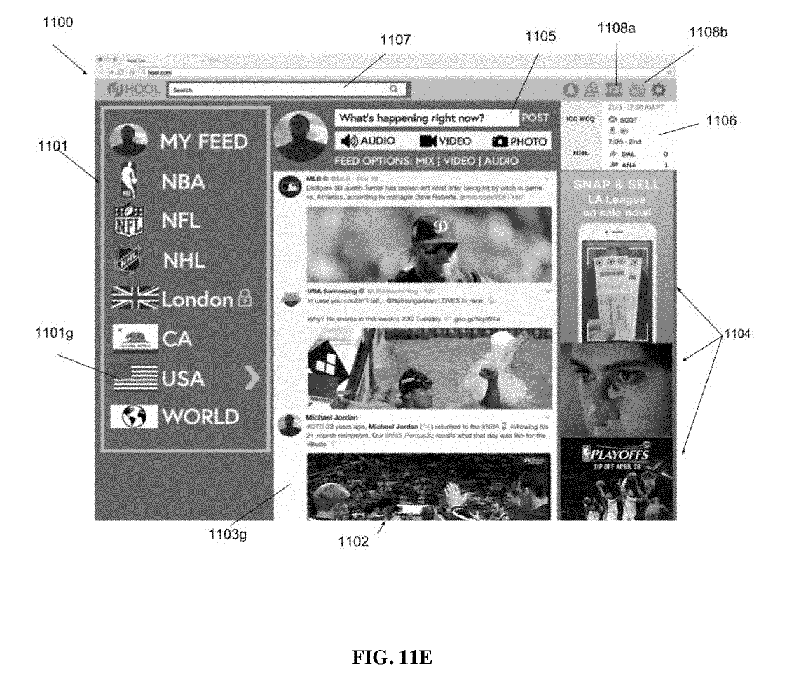

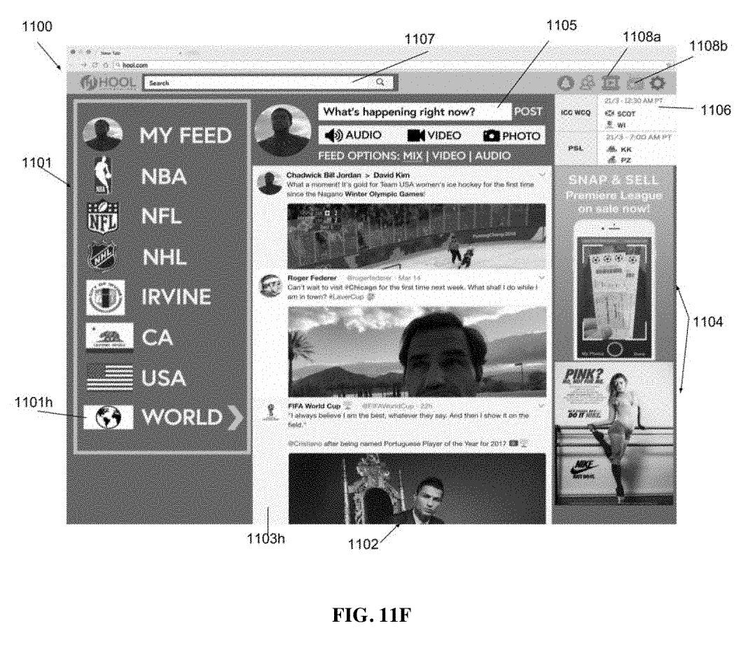

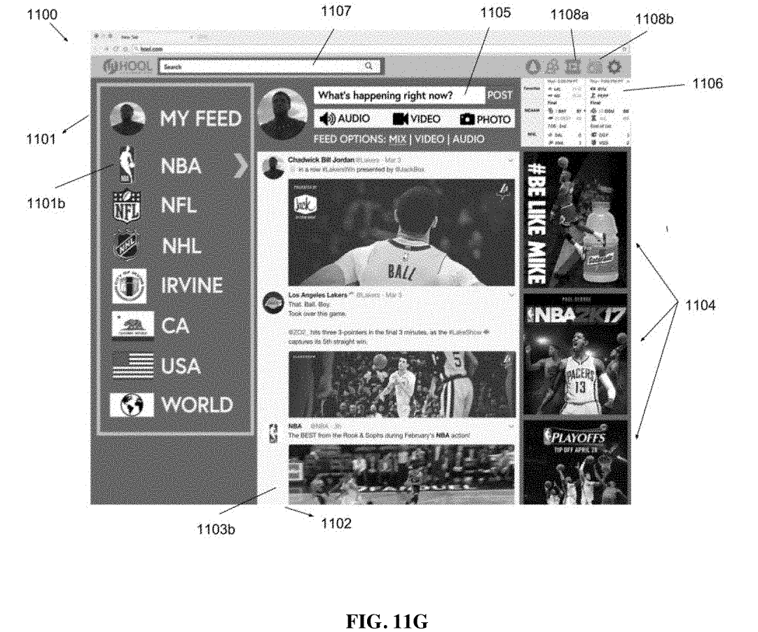

FIGS. 11A-11G illustrate specific examples of a user interface 1100 showing views specific to a sports-location-based (“entertainment location-based”, “Interest-location based”) social media platform accessed on a computer showing personalized sports feed relevant to the user selected locations, according to an aspect. FIGS. 11A-11G shows example of a sports-location-based social media platform when accessed through a website on desktop computer or a laptop. As shown in FIGS. 11A-11G, any topic may be selected from menu 1101 to generate a personalized feed page in a personalized view panel 1102 for a user. The personalized view panel 1102 may include news and posts relevant to a specific interest or topic, sports as an example, at a specific location chosen from menu 1101. The user may also make personal posts as text, audio, video, image in post section 1105. The advertisement panel 1104 on the right may display customized advertisements relevant to the selected sports at a chosen location. Further, the feature of integrating text-to-speech through video 1108a and audio 1108b is also shown in FIGS. 11A-11G, wherein a user with visual impairment may play feed displayed in personalized view panel 1102. Furthermore, the feature of integrating text-to-speech through video 1108a and audio 1108b, as shown in FIGS. 11A-11G, may be used by users while multi-tasking. There is also an option to conduct wild-card searches 1107 within sports feed displayed in personalized view panel 1102.

As shown in FIG. 11A, selection of personal feed 1101a displays a personalized sports feed 1103a. As an example, the personalized sports feed 1103a in FIG. 11A displays posts from the user and personalized feeds from NFL (National Football League). In addition, as an example, ads shown in advertisement panel 1104 in FIG. 11A relate to user's post about NFL.

FIG. 11B illustrates an example of sports feed 1103e generated at city level when Irvine 1101e is picked as the city of residence. The sports feed 1103e in FIG. 11B is configured from different sources i.e. it displays post from the user about volleyball, a post from another user about a sports bar in Irvine, and an update related to soccer generated from a news source in Irvine. Accordingly, the ads displayed in advertisement panel 1104 in FIG. 11B relate to happy hour at a restaurant in Irvine, places in Irvine for business and fun, and tickets for an upcoming match in Irvine.

As shown in FIG. 11C, the user has locked a city London 1101i. Accordingly, in FIG. 11C, all the sports feed 1103i generated in personalized view panel 1102 and ads displayed in advertisement panel 1104 relate to sports in London.

FIG. 11D relates to sports at state view and shows California 1101f as an example. The personalized view panel 1102, shown in FIG. 11D, generates sports related feed 1103d, displaying news relevant to sports in California and personal posts about a player and events in different cities of California. Accordingly, the ads displayed in advertisement panel 1104 relate to tickets for a sports league in California.

The user interface 1100 in FIG. 11E shows country view with USA as an example in menu 110 thereby generating feeds and posts in personalized view panel 1102 and ads in advertisement panel 1104 relating to popular sports in USA e.g. swimming, baseball, basketball, football. As seen in FIG. 11F, an example of sports at world view 1101h, when selected in menu 1101, displays sports specific feed 1103f in personalized view panel 1102 which includes news from the sports websites like FIFA world cup and posts from the users and sports celebrities from all over the world.

The menu 1101 in FIG. 11G shows NBA (National Basketball Association) 1101b, as an example of basketball as a sport interest followed by the user. Accordingly, the personalized view panel 1102 configures a Basketball specific sports feed displaying news, events, posts specific to basketball.

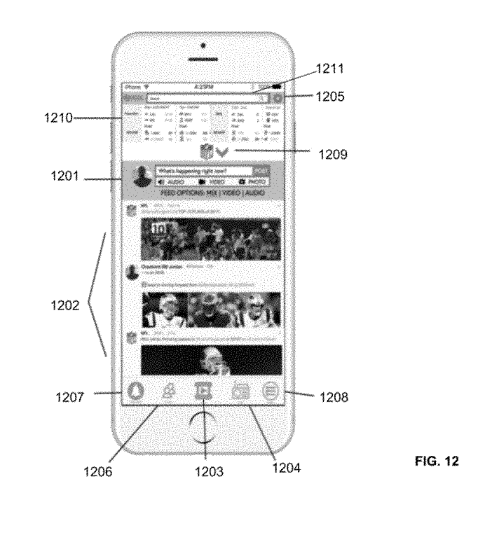

FIG. 12 illustrates an example of a user interface accessed on a mobile device by a user to use a location- or interest-based social media platform showing a view of news feed and other relevant content specific to sports, according to an aspect. The user has an option to make personal posts as text, photo, audio or video through post section 1201. The user may also select locations, interests or any other customization from Toggle feed icon 1209 which will determine content to be displayed in news feed 1202. As an example, the news feed 1202 may display the news relevant to the selected sports and score 1210 may display the scores of the live and past matches of interest. The user may select other users from friends 1206 to further customize the feed with posts from such users. Furthermore, the mobile user interface provides feature of text-to-speech through video feed 1203 and audio feed 1204. Also, the user may search 1211 for specific topics in the news feed 1202 or all the posts by the user and user's friends from said social media platform. The settings 1205 and more options 1208 in general user interface in FIG. 12 provides features of sign in, sign out, permissions, help & support, privacy, various other options.

It should be understood that the location-based or interest-based social media platform may be adapted for different industries, interests, or hobbies, and may be also used as a marketplace for buying, selling, and trading. As an example, the sports-related feed may be accessed by the user as a selection within the social media platform's menu bar, or may be the single focus of the social media platform for users who only need the social media platform for a single type of interest. Thus, the social media platform may be customizable for users with different needs and interests.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A method for searching or viewing on a social media platform having location-based capabilities in a general user interface comprising:
i. selecting a geographical region from a menu with various locations provided to a user;
ii. displaying relevant content as feeds in a personalized view panel generated based upon selection of a specific location from said menu for said user to view or post;
iii. searching for any desired content within real-time feeds displayed in said personalized view panel;
iv. integrating with text-to-speech features thereby accessing said displayed content in a video or audio format in said personalized view panel;
v. providing single or plurality of advertisements to said user in an advertisement panel generated based upon location selected by said user.

2. The method of claim 1, wherein selecting a geographical region from a menu with various locations comprises a city view, a state view, a country view, or a world view for selection by said user to search, view or post content relevant to said geographical region.

3. The method of claim 1, wherein said user can select one or several locations from said menu to search, view or post content relevant to said selected one or several locations.

4. The method of claim 1, wherein displaying relevant content as feeds in a personalized view panel comprises: determining content relevant to selected location from said menu of a personal view, a city view, a state view, a country view, a world view; selecting source where content will be generated from, and customizing content specific to selected location by said user.

5. The method of claim 4, wherein said source where content will be generated from comprises of selected location based websites relating to news, events, informational announcements, sports updates, job listing.

6. The method of claim 4, wherein displaying relevant content comprises news, event information, announcements, posts from other users in selected location, job listings, any other information specific to selected location.

7. The method of claim 1, wherein displaying relevant content as feeds in a personalized view panel further comprises visual representation to signify type, location, origin of posts, or user who has made certain post.

8. The method of claim 6, wherein said visual representation includes color-coding, general use icons, celebrity icons, government signs and symbols.

9. The method of claim 1, wherein searching for any desired content within real time feeds comprises searching for specific terms within content posted to a selected location from said menu of a personal view, a city view, a state view, a country view, a world view.

10. The method of claim 1, wherein searching for any desired content within real time feeds further comprises holding peer-to peer interaction on specific forums related to specific topic.

11. The method of claim 2, wherein said personal view when selected displays posts personal to said user or said user's selected friends from said social media platform.

12. The method of claim 11, wherein said personal view when selected displays posts at one or various locations selected by said user from said menu.

13. The method of claim 1, wherein said menu further provides an option to lock one or more locations from said menu said user is interested in visiting to view or post content specific to said locked location; said personalized view panel displays relevant content specific to said locked location; ability to search for specific content in said displayed content for said locked location; and said advertisement panel provides advertisement for said locked location.

14. The method of claim 1, wherein said user may post content publicly, anonymously, to self, to group of other users of social media platform, at different geographical regional levels available in said menu.

15. The method of claim 1, wherein said integrated text-to-speech feature plays content as video or audio on external devices such as televisions, computers, smart phones, or laptops.

16. The method of claim 1, providing single or plurality of advertisements to each user in a panel comprises general or customized advertisements.

17. A method for searching or viewing on a social media platform having interest-based capabilities in a general user interface comprising:
i. selecting a specific interest from a menu with various interests provided to a user;
ii. displaying relevant content as feeds in a personalized view panel generated based upon selection of a specific interest from said menu to view or post;
iii. searching for any desired content within real time feeds displayed on said personalized view;
iv. integrating with text-to-speech features thereby accessing said displayed content in a video or audio format in said personalized view;
v. providing single or plurality of advertisements to each user in an advertisement panel generated based upon the selection of said interest by said user.

18. The method of claim 17, wherein selecting a specific interest from a menu comprises any topic or industry of sports, fashion, medical, cross-posting from other social media platforms, events, trends to view in said personalized view panel.

19. The method of claim 17, wherein displaying relevant content as feeds in a personalized view panel comprises: configuration of feed in said personalized view panel from settings provided in said menu, choosing different sources where content will be generated from, and viewing relevant contents related to said interest.

20. The method of claim 17, wherein searching for any desired content within real time feeds comprises searching for specific terms within content posted for said interest in said personalized view panel.

21. The method of claim 17, wherein said integrated text-to-speech feature plays content as video or audio on external devices such as televisions, computers, smart phones, laptops.

22. The method of claim 17, wherein providing single or plurality of advertisements to each user in a panel comprises general or customized advertisements.

23. A method for searching or viewing on a social media platform in specific interest at specific location in a general user interface comprising:
i. selecting a specific interest from a menu with various interests provided to a user;
ii. selecting a geographical region from a menu with various locations provided to said user;
iii. displaying relevant content as feeds in a personalized view panel generated based upon the selection of a specific interest at a specific location from said menu to view or post;
iv. searching for any desired content within real time feeds displayed on said personalized view;
v. integrating with text-to-speech features thereby accessing said displayed relevant content in a video or audio format in said personalized view;
vi. providing single or plurality of advertisements to each user in an advertisement panel generated based upon the selection of said interest at a specific location by said user.

24. The method of claim 23, wherein selecting a specific interest from a menu comprises any topic or industry of sports, fashion, politics, health, science, technology, hobbies, cross-posting from other social media platforms, events, trends to view in said personalized view panel.

25. The method of claim 23, wherein selecting a geographical region from a menu with various locations comprises a city view, a state view, a country view, or a world view for selection by the user to search, view or post content relevant to said geographical region.

26. The method of claim 23, wherein displaying relevant content as feeds in a personalized view panel comprises configuration of feed in said personalized view panel from settings provided in said menu, choosing different sources where content will be generated from, and viewing relevant contents related to said interest at selected location.

27. The method of claim 23, wherein searching for any desired content within real time feeds comprises searching for specific terms within content posted to a selected location from said menu of a personal view, a city view, a state view, a country view, and a world view.

28. The method of claim 23, wherein said integrated text-to-speech feature plays content as video or audio on external devices such as televisions, computers, smart phones, laptops.

29. The method of claim 23, providing single or plurality of advertisements to each user in a panel comprises general or customized advertisements.

30. A method for searching or viewing on sports location-based social media platform in a general user interface comprising:
i. selecting sports of interest from a menu provided to a user;
ii. selecting favorite teams from said menu provided to a user;
iii. selecting a geographical region from a menu with various locations provided to said user;
iv. selecting sources related to said sports of interest and said favorite teams from selected location to generate relevant content;
v. displaying relevant content as feeds in a personalized view panel customized based upon selection of said sports of interest and said favorite teams for selected location;
vi. searching for any desired content within real time feeds displayed on said personalized view;
vii. integrating with text-to-speech features thereby accessing said displayed relevant content in a video or audio format in said personalized view;
viii. providing single or plurality of advertisements to each user in an advertisement panel generated based upon selection of said sports of interest, said favorite teams and said selected geographic region.

31. The method of claim 1, 17, 23, or 30, wherein said social media platform can be accessed through any device with a connection to internet like computer or a mobile device wherein said computer can be a desktop, tablet, or laptop.
